(19) United States
(12) Patent Application Publication
(10) Pub. No.: US 2014/0201020 A1
(43) Pub. Date: Jul. 17, 2014

(54) MOVING COST ESTIMATION SYSTEM

(71) Applicant: FREE MOVING PRICE.COM, INC., Sunrise, FL (US)

(72) Inventors: Alan Horowitz, Sunrise, FL (US); Mitchell Fields, Needham, MA (US)

(73) Assignee: Free Moving Price.Com, Inc., Sunrise, FL (US)

(21) Appl. No.: 13/856,175

(22) Filed: Apr. 3, 2013

Related U.S. Application Data
(63) Continuation of application No. 13/740,834, filed on Jan. 14, 2013.

(51) Int. Cl. G06Q 30/06

(52) U.S. Cl. CPC G06Q 30/0611
USPC 705/26.4

(57) ABSTRACT

A method for estimating costs associated with relocating a plurality of items is provided. An interface is provided to a device. The interface receives user input data associated with relocating a plurality of items and displays a plurality of cost estimates that includes a total moving cost. The plurality of cost estimates are based at least in part on predefined item cost and user input data. At least one of the plurality of cost estimates is dynamically updated after at least a portion of the user input data is received. At least one of an estimate sheet and moving tariff form is provided. The estimate sheet is based at least in part on the plurality of cost estimates and received user input data. The moving tariff form provides a list of at least one charge and service associated with the plurality of cost estimates.

### CROSS-REFERENCE TO RELATED APPLICATION

This application is a continuation-in-part-of Utility patent application Ser. No. 13/740,834, filed Jan. 14, 2013, entitled MOVING COST ESTIMATION SYSTEM, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for estimating moving cost.

### BACKGROUND OF THE INVENTION

Moving personal or business property can be a complicated and often time consuming process. The moving process may require several types of services such as packers, haulers and temporary storage services in which each service provider may require prolonged telephone conversations or inspections in order to generate a quote for a specific service. For example, a packing and hauling service provider may have to visit a home or business in order to inspect the items to be moved. Rarely does the on-site inspector generate a quote for these services on the spot such that the consumer will have to wait days to receive the quote.

Moreover, as moving companies typically have limited personnel, a customer may have to make an appointment days, even weeks, in advance just to get the inspector to visit the property. Also, some companies charge customers an inspection fee just to have an inspector visit the property. In other words, some companies charge a fee just to generate a quote. Some moving service providers have tried to simplify the quote process by prompting the consumer to fill out online questionnaires such that pertinent moving information is received by the provider.

However, most of the time, these online questionnaires are simply lead generation forms in which the moving service provider will subsequently contact the customer to set up an inspection. Even if the online questionnaire leads to a quote without having an inspector visit the property, the provided quote is not instant as the consumer is often directed to call a contact number at the end of the questionnaire process in order to get the quote.

Some moving service providers supply an online quote but these moving service providers are typically limited to small “do-it-yourself” moves in which the customer is renting a moving vehicle and buying moving supplies. These moving service providers typically do not provide packing/unpacking services. Further, the online quotes are not customizable in that the user is required to re-enter all his/her information if another quote or modified quote is desired. For example, if the calculated quote is too high, the user will have to re-submit all the related user information in order to acquire another online quote that is hopefully more in-line with the consumer's budget. This process is often frustrating to the consumer and may lead to lower customer conversion, i.e., the customer actually using the moving service provider's services.

Moreover, the provided online quote is only one moving service in a move that will likely require several different moving services. For example, while the customer can get an online quote for renting a moving truck, the same customer has to visit another website to get another price quote for packing/unpacking services. In other words, having to visit multiple websites to get various prices quotes for different moving services may quickly lead to user frustration, thereby further inhibiting customer conversion.

### SUMMARY OF THE INVENTION

The present invention advantageously provides a method and system for estimating moving cost, generating at least one estimate sheet of moving cost and generating at least one moving tariff form.

In accordance with another aspect of the invention, a system for estimating costs associated with relocating a plurality of items is provided. The system including an apparatus. The apparatus including a receiver arranged to receive user input data associated with relocating a plurality of items. The apparatus further including a processor configured to provide an interface to at least one device. The interface configured to receive the user input data associated with relocating a plurality of items. The interface further configured to transmit user input data to the apparatus. The interface further configured to calculate a plurality of cost estimates that includes a total moving cost. The plurality of cost estimates are based at least in part on cost data and the user input data. At least one of the plurality of cost estimates is dynamically updated after at least a portion of the user input data is transmitted. The interface is further configured to display the calculated plurality of cost estimates. The processor is further configured to determine the cost data associated with the received user input data. The apparatus further includes a transmitter arranged to transmit the cost data.

In accordance with another aspect of the invention, a method for estimating costs associated with relocating a plurality of items is provided. User input data associated with relocating a plurality of items is received. The user input data is transmitted. Cost data is received in response to the transmitted user input data. At least a portion of the cost data is predefined by a moving service provider. A plurality of cost estimates including a total moving cost is calculated. The plurality of cost estimates are based at least in part on cost data and the user input data. At least one of the plurality of cost estimates are dynamically updated after at least a portion of the user input data is transmitted. The calculated plurality of cost estimates are displayed.

In accordance with another aspect of the invention, a method for estimating costs associated with relocating a plurality of items is provided. A website interface is provided to at least one device. User data input from the website interface is received. The user input data is associated with relocating a plurality of items. Cost data associated with the user input data is determined. The determined cost data is transmitted to the website interface for use in calculating a plurality of cost estimates. At least a portion of the cost data is predefined by a moving service provider.

In accordance with another aspect of the invention, a system for estimating costs associated with relocating a plurality of items is provided. The system includes an apparatus. The apparatus includes a processor configured to provide an interface to a device. The interface configured to receive user input data associated with relocating a plurality of items. The interface is further configured to display a plurality of cost estimates including a total moving cost, the plurality of cost estimates being based at least in part on predefined cost data and user input data, at least one of the plurality of cost estimates being dynamically updated after at least a portion of the user input data is received. The apparatus is further configured to provide at least one of an estimate sheet and moving tariff form. The estimate sheet is based at least in part on the plurality of cost estimates and received user input data. The moving tariff form provides a list of at least one charge and service associated with the plurality of cost estimates.

In accordance with another aspect of the invention, a method for estimating costs associated with relocating a plurality of items is provided. An interface is provided to a device. The interface is configured to receive user input data associated with relocating a plurality of items. The interface is further configured to display a plurality of cost estimates that includes a total moving cost. The plurality of cost estimates are based at least in part on predefined item cost and user input data. At least one of the plurality of cost estimates is dynamically updated after at least a portion of the user input data is received. At least one of an estimate sheet and moving tariff form is provided. The estimate sheet is based at least in part on the plurality of cost estimates and received user input data. The moving tariff form provides a list of at least one charge and service associated with the plurality of cost estimates.

In accordance with another aspect of the invention, a system for estimating costs associated with relocating a plurality of items. The system includes an apparatus. The apparatus includes a processor configured to provide an interface to a device. The interface is configured to receive user input data associated with relocating a plurality of items. The interface is further configured to display a plurality of cost estimates including a total moving cost. The plurality of cost estimates is based at least in part on predefined cost data and user input data. At least one of the plurality of cost estimates is dynamically updated after at least a portion of the user input data is received. The processor is further configured to provide at least one of a estimate sheet and moving tariff form. The estimate sheet is based at least in part on the plurality of cost estimates and received user input data. The moving tariff form provides at list of at least one charge and service associated with the plurality of cost estimates. The system further includes a database in communication with the apparatus. The database is configured to store cost data, the cost data including a plurality of individual item costs, motor vehicle cost, fuel cost and mover labor rate. The motor vehicle cost and fuel cost are based at least in part on a distance from the first pick-up location to the first destination location. The database is configured to provide cost data to the apparatus. The total moving cost is based at least in part on the individual item cost, motor vehicle cost, fuel cost and labor rate.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary moving cost estimation system, constructed in accordance with the principles of the present invention;

FIG. 2 is a first page of an exemplary interface, constructed in accordance with the principles of the present invention;

FIG. 3 is a second page of the exemplary interface, constructed in accordance with the principles of the present invention;

FIG. 4 is a third page of the exemplary interface, constructed in accordance with the principles of the present invention;

FIG. 5 is a fourth page of the exemplary interface, constructed in accordance with the principles of the present invention;

FIG. 6 is a fifth page of the exemplary interface, constructed in accordance with the principles of the present invention;

FIG. 7 is a sixth page of the exemplary interface, constructed in accordance with the principles of the present invention;

FIG. 8 is a flow chart of an exemplary cost process in accordance with the principles of the present invention; and

FIG. 9 is a flow chart of an exemplary interface process in accordance with the principles of the present invention;

FIG. 10 is a block diagram of an alternative moving cost estimation system, constructed in accordance with the principles of the present invention; and

FIG. 11 is a flow chart of a second cost process in accordance with the principles of the present invention.

### DETAILED DESCRIPTION OF THE INVENTION

The present invention advantageously provides an apparatus, system and method for moving cost estimation. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

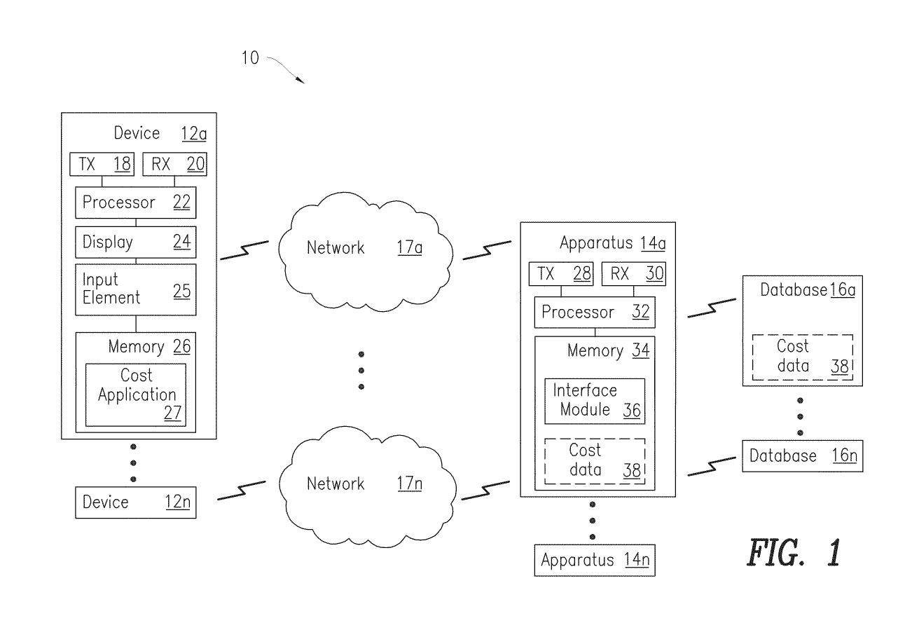

Referring now to drawing figures in which like reference designators refer to like elements there is shown in FIG. 1 an exemplary moving cost estimation system constructed in accordance with the principles of the present invention and designated generally as “10.” System 10 includes one or more devices 12a to 12n (collectively referred to as “device 12”), one or more apparatuses 14a to 14n (collectively referred to as “apparatus 14”), one or more databases 16 (collectively referred to as “database 16”) and one or more communication networks 17a to 17n (collectively referred to as “network 17”).

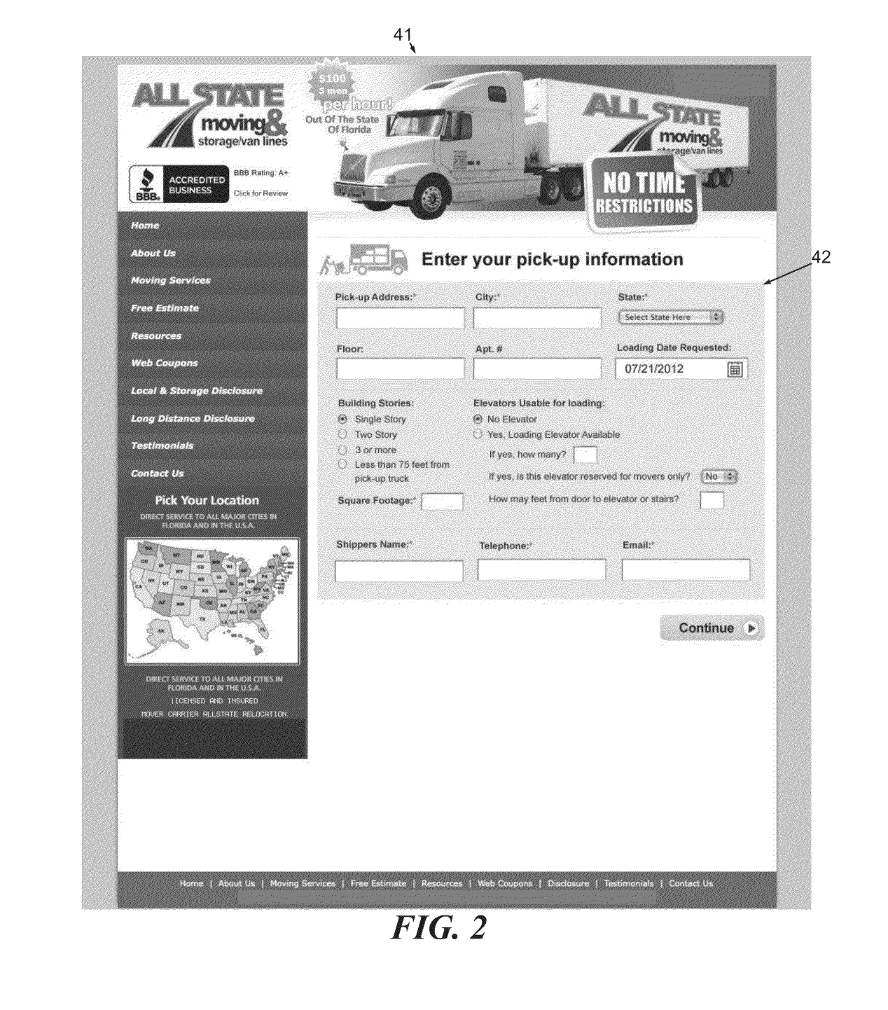

Device 12 may be a smart phone, laptop computer, tablet computer, user terminal and personal computer, among other devices capable of performing the functionality of device 12 as described herein. Device 12 may include one or more transmitters (TX(s)) 18 and one or more receivers (RX(s)) 20 for communicating with apparatus 14 and/or database 16 via network 17. Processor 22 may be one or more central processing units (CPUs) for performing device 12 functions described herein. Device 12 further includes memory 26 in communication with processor 22. Device 12 further includes display 24 that is arranged to display interface 41 (FIGS. 2-7). Display 24 may be a liquid crystal display (LCD) or light emitting diode (LED) based display or other display known in the art that is capable of displaying a website interface. Device 12 further includes input element 25 that is arranged to receive user inputs from user of device 12. Input element 25 may be a keyboard, touch screen keyboard and/or computer mouse, among other input device that allows a user to input data related to a move.

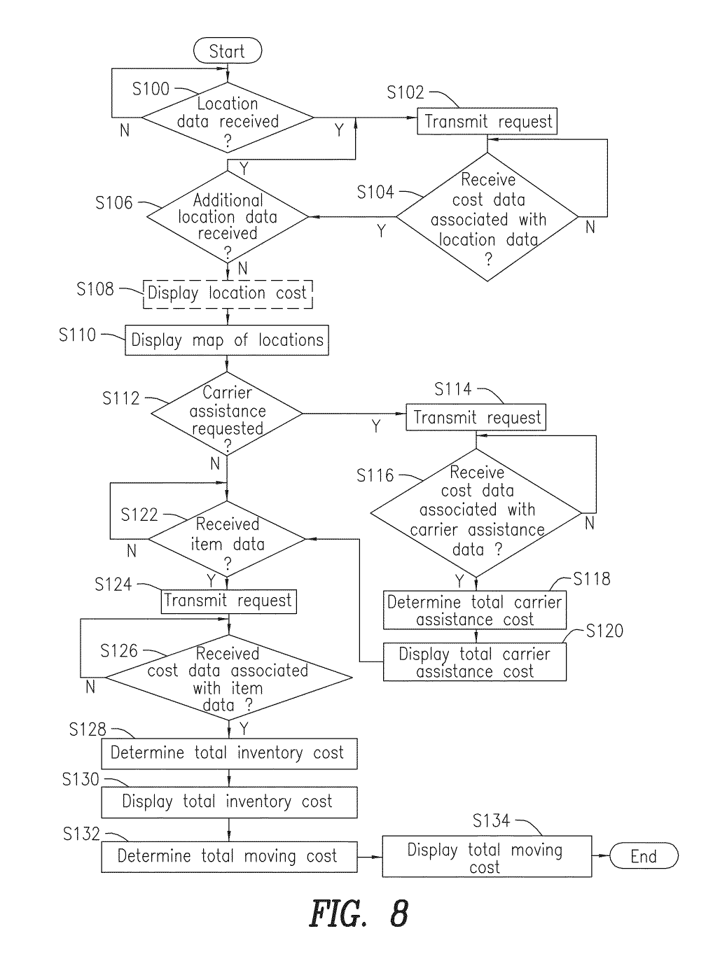

Memory 26 may include non-volatile and volatile memory. For example, non-volatile memory may include a hard drive, flash memory, memory stick and the like. Also, volatile memory may include random access memory and others known in the art. Memory 26 may store program instructions such as those for cost application 27. In particular, cost application 27 includes instructions, which when executed by processor 22, causes processor 22 to perform the cost application process, discussed in detail with respect to FIG. 8. For example, cost application 27 provides interface 41 that performs the Blocks of FIG. 8. Further, memory 26 may store user input data such that the user of device 12 may modify previously input moving information at a later time without having to re-input all the moving information, e.g., a user of device 12 may add or subtract items and/or services as needed. Alternatively, the user input data may be stored at apparatus 14 and/or database 16.

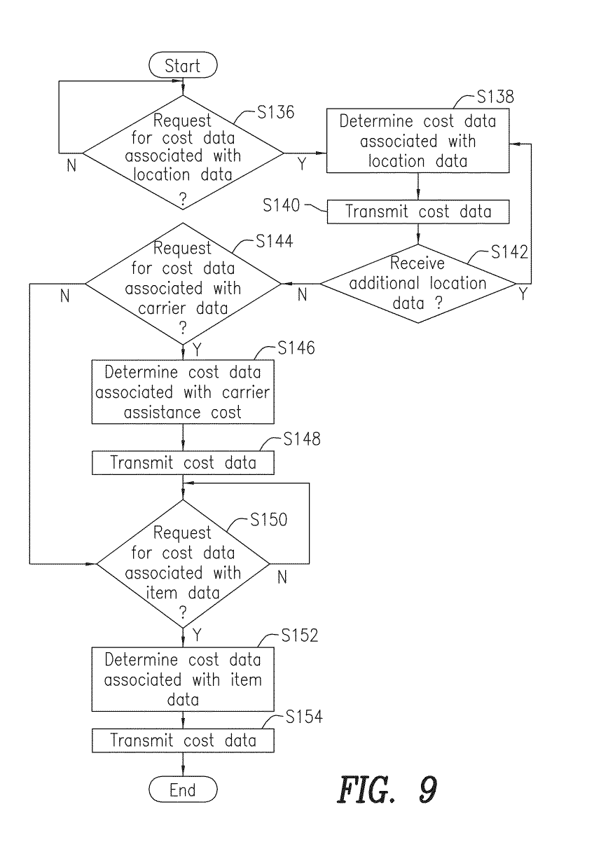

Apparatus 14 includes one or more transmitters 28 and receivers 30 arranged to communicate with device 12 and/or database 16. Apparatus 14 further includes one or more processors 32 in communication with one or more transmitters (TX(s)) 28 and one or more receivers (RX(s)) 30. Processor 32 is configured to perform apparatus 14 functions described herein. Apparatus 14 includes memory 34 in communication with processor 32 that generally corresponds to memory 26 with size and performance being adjusted based on design needs. Memory 34 may store program instructions such as those for interface module 36, among other modules. Interface module 36 includes program instructions, which when executed by processor 32, causes processor 32 to perform the interface process that supplies requested cost data, described in detail with respect to FIG. 9.

Cost data 38 includes cost values corresponding to or based on items, item weight, distance, stops, time, supplies, equipment cost and/or services associated with relocating one or more items, e.g., furniture. Cost data 38 may be predefined and dynamically updated by a moving service provider. Alternatively, cost data 38 may not be stored in memory 34 but in database 16 as discussed below. Further, memory 34 may store user input data such that the user of device 12 may modify previously input moving information at a later time without having to re-input all the moving information, e.g., a user of device 12 may add or subtract items and/or services as needed. Alternatively, the user input data may be stored at device 12 and/or database 16.

System 10 may also include one or more databases 16a to 16n (collectively referred to as “database 16”). Database 16 may be a structured query language (“SQL”) based database such as a MYSQL database or other type of database known in the art. Database 16 may store cost data 38 and user input data, among other data, as described above with respect to apparatus 14. Network 17 may include an internet protocol (“IP”) network, wireless communication network, cellular communication network and public switched telephone network (“PSTN”), among other types of networks known in the art that may be established as a wide area network (“WAN”) and/or local area network (“LAN”), such as an Ethernet LAN, among other IP-based networks.

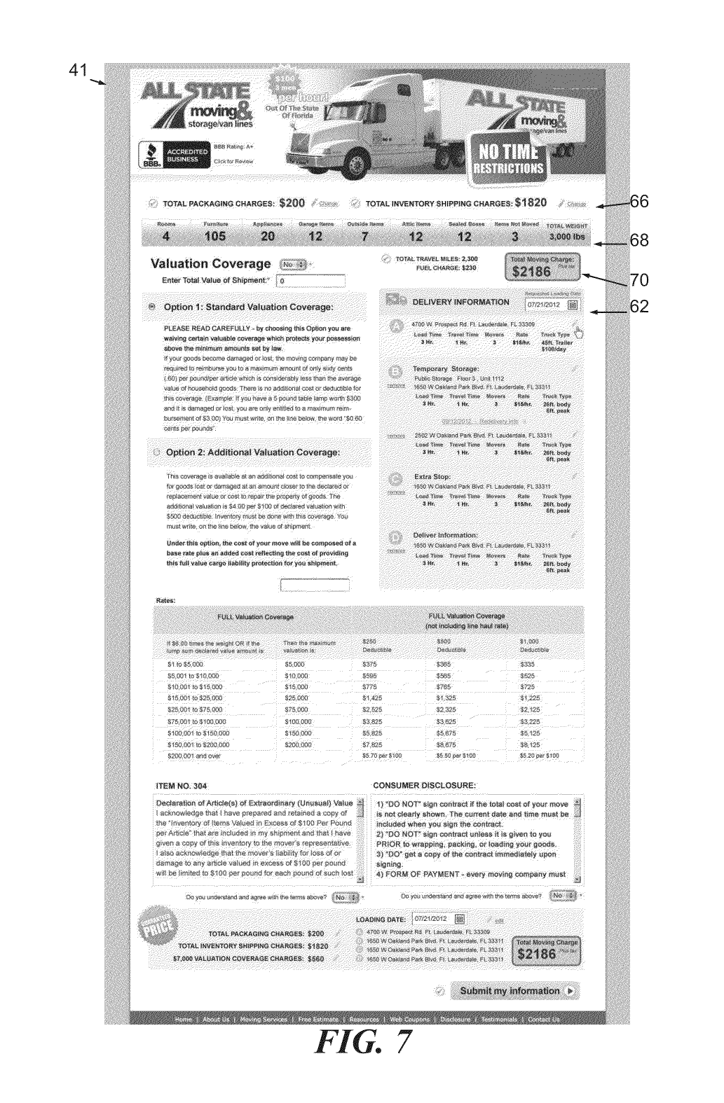

FIG. 2 is an exemplary first page of website interface 41 that is provided to device 12 by apparatus 14. Interface 41 is configured to receive user input data associated with relocating a plurality of items and display a plurality of cost estimates or quotes in which the plurality of cost estimates are based at least in part on cost data 38 and user input data. The plurality of cost estimates may be dynamically updated after at least a portion of the user data has been received, i.e., dynamically updated as the user enters or modifies user input data received at interface 41 via input element 25. For example, website interface 41 may request cost data associated with each input by the user as the user input data is received such that the estimates are dynamically calculated by processor 22. First page of website interface 41 includes pick-up information section 42 in which a user is prompted to enter information, i.e., user input data, associated with a pick-up location. For example, the pick-up information may include a pick-up location address and pick-up location characteristics, among other information related to the pick-up location. Pick-up location characteristics may include building stories, elevators usable for loading, square footage and number of feet from user's door to elevator, among other information associate with the pick-up location. The pick-up location characteristics are used to determine the number of movers or size of the moving team needed to relocate the items and an estimated time needed to relocate each item, i.e., loading/unloading time. The hourly rate of the number of movers and the estimated time are used to calculate, in part, the total moving cost (FIG. 7).

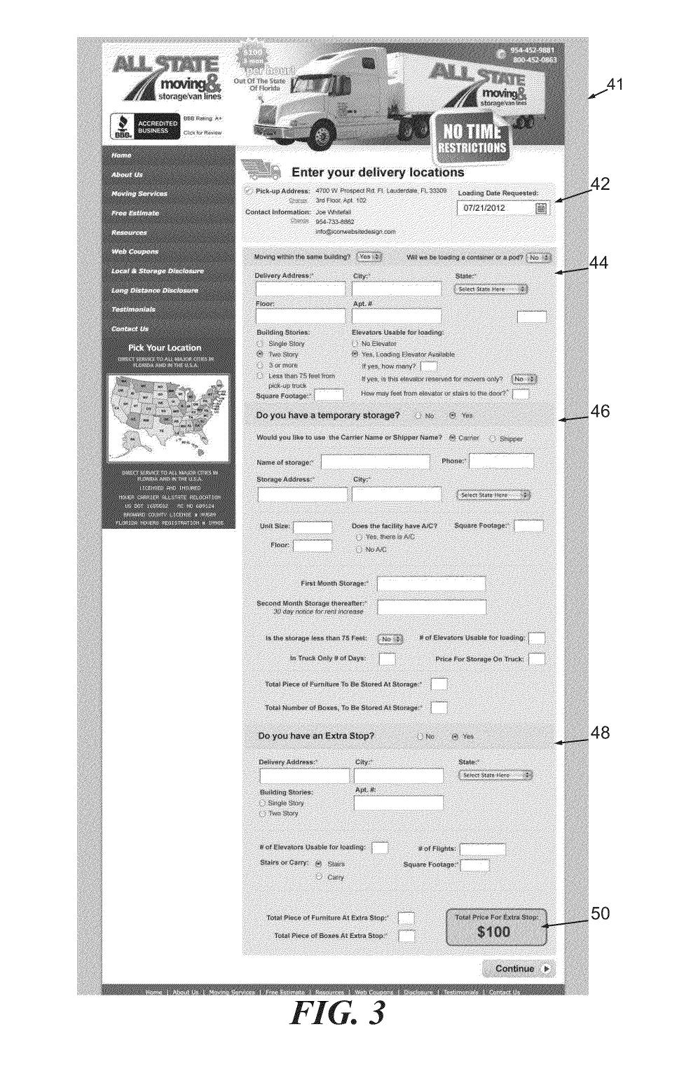

FIG. 3 is an exemplary second page of website interface 41 that is provided to device 12. Second page of website interface 41 includes a summary of pick-up information section 42, delivery section 44, temporary storage section 46, extra stop section 48 and total extra stop cost 50. The summary of pick-up information section 42 is a summary of the user input data that was entered in the first page of website interface 41 as described above with respect to FIG. 2. The summary of pick-up information section 42 allows the user to change or modify information as required without having to re-enter all the previously entered user input data, e.g., the user can change the pick-up location characteristics without having to re-enter the address information. Delivery section 44 allows user to enter delivery information, i.e., user input data, associated with a delivery location where one or more of the items are to be relocated or dropped off. For example, the delivery location may be a final destination address where any remaining relocated items on a moving vehicle are to be dropped off. The delivery information may include delivery location characteristics such as building stories, square footage, elevators usable for loading and the number of feet from elevator or stairs to the door, among other information associated with the delivery location may be used to estimate moving cost(s).

Temporary storage section 46 allows the user to enter information associated with storing at least one item to be relocated. For example, temporary storage section 46 may prompt the user for storage facility information, storage room characteristics and number of items to be stored, among other information associated with temporary storage of relocated items that may be used to estimate moving cost(s). Storage room characteristics may include unit size, floor number, whether air conditioning is provided and square footage, among other information associated with the storage room. Also, the user may indicate that no temporary storage information will be entered in which the user may later return to update temporary storage section 46.

Extra stop section 48 allows the user to enter extra stop information, i.e., extra stop data, related to one or more extra stops that are added to the travel path from the pick-up location to the delivery location. In particular, an extra stop may be an additional pick-up location or delivery location, e.g., second pick-up or delivery location. The extra stop information may include a location address, building characteristics associated with the extra stop, total pieces of furniture to be dropped off or picked up at the extra stop and total boxes to be dropped off or picked up at the extra stop, among other information associated with the one or more extra stops that may be used to calculate the extra stop cost estimate. Extra stop section 48 also displays the extra stop cost estimate that indicates the price associated the extra stop.

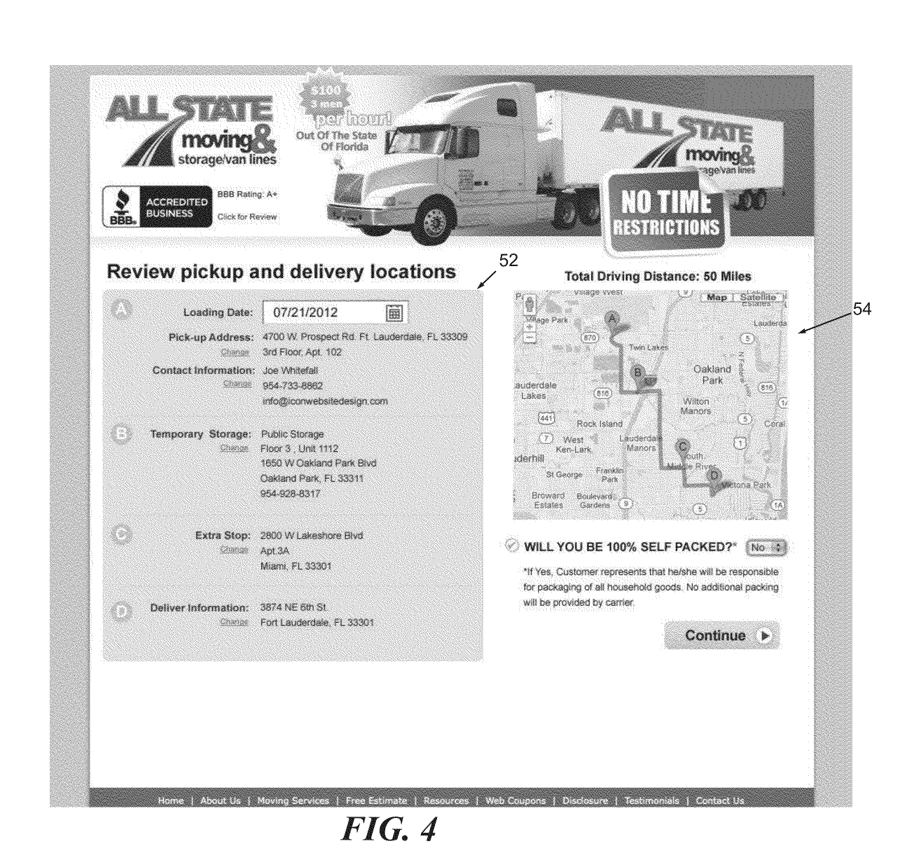

A third page of website interface 41 is illustrated with respect to FIG. 4. Third page of website interface 41 includes summary of locations 52 and mapping 54 of summary of locations 52. Summary of locations 52 includes information, i.e., user input data, corresponding to a pick-up location, delivery location, optional temporary storage location and optional extra stop(s). Summary of locations 52 allows the user to change or modify information related to one or more locations without having to resubmit all previously entered user input data, thereby facilitating user customization of the estimated cost(s), i.e., user may remove an extra stop to reduce cost or may choose an extra stop closer to the delivery location to reduce cost associated with the travel distance. Mapping 54 is a geographical map that displays the locations corresponding to the user input data and further displays the path of travel from the pick-up location to the delivery location.

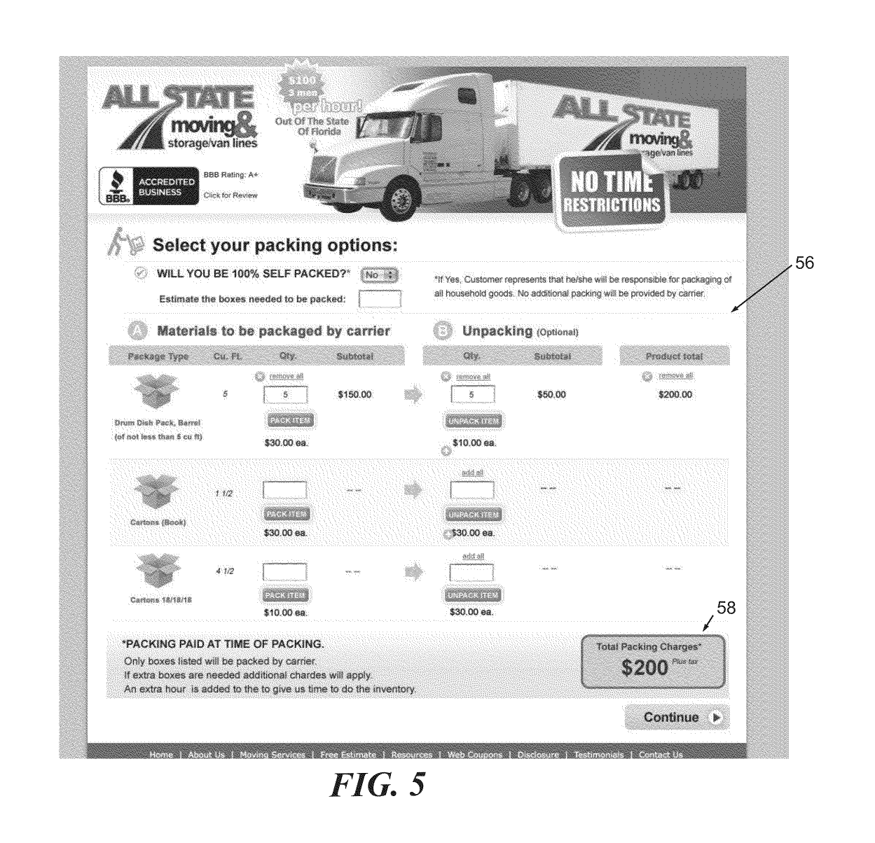

FIG. 5 illustrates a fourth page of website interface 41 that includes carrier assistance section 56. Carrier assistance section 56 allows the user to enter information related to carrier packing and/or unpacking services. For example, the user may indicate that one or more items are to be packed by the carrier in which the user indicates the amount of boxes needed to pack the item(s). The user may also indicate the amount of boxes that need to be unpacked by the carrier. An estimated cost associated with packing and/or unpacking by the carrier is displayed in total packing charges section 58, e.g., “$200”, such that the user may modify or adjust the user input data associated with carrier assisted packing to suit the user's needs and budget. Alternatively, the user may indicate no carrier assistance is needed.

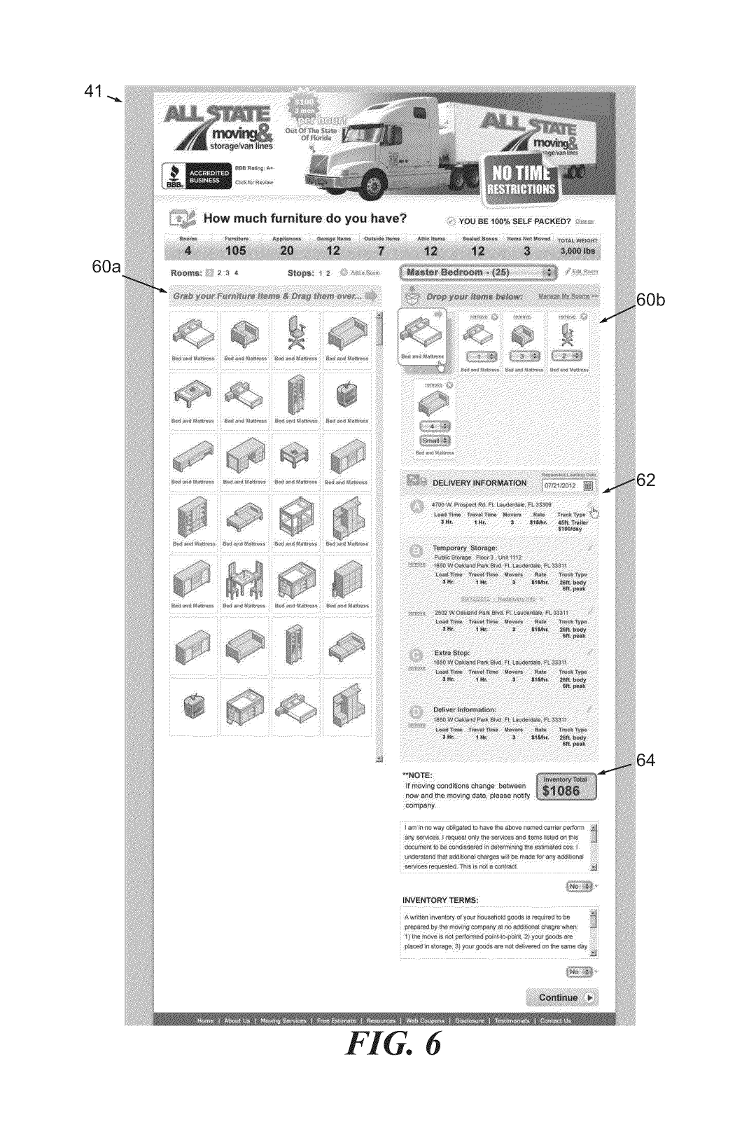

Referring to FIG. 6, there is illustrated an exemplary fifth page of website interface 41. The fifth page includes interactive furniture section 60a-60b, logistics section 62 and total inventory cost section 64. Interactive furniture section 60a allows a user to drag and drop furniture icons corresponding to items to be relocated into a predefined box section 60b such that the total number of items and item characteristics of the items to be relocated are tracked. For example, the user may customize the name(s) of box 60b to correspond to specific room, e.g., master bedroom, in which the user drags one or more furniture icons from section 60a to box section 60b such that system 10 is able to keep track of the items and items characteristics associated with items to be relocated. The user can dynamically modify the items “dropped” in box section 60b. The number of items and/or item characteristics are used in part to determine total inventory cost. For example, the item characteristics may indicate an estimated weight of an item in which the weight of the item is used in part to determine fuel cost (illustrated in FIG. 7).

Apparatus 14 and/or device 12 may printable labels and/or generate labels to be printed based at least in part on the user input data, e.g., user input data associated with section 60a and 60b. For example, the printable labels may be tracking labels for each item to be relocated in which each tracking label may include the originating and target rooms for delivery. Alternatively, the tracking label may indicate the originating room, e.g., master bedroom, and a delivery location such as temporary storage. Tracking labels help streamline the moving process by allowing the user to predetermine the exact relocation destination of the items and giving the moving service provider a “blueprint” of exactly where each item is to be relocated.

Logistics section 62 includes a summary of location logistics based on the user input data. The summary of location logistics may indicates a load time, travel time, number of required movers, hourly rate for movers (labor rate), truck type and hourly truck rate, among other information. For example, logistics section 62 may include a summary of location logistics for the pick-up location that indicates a load time of three hours, travel time of one hour, three movers are required, fifteen dollar hourly rate, a forty-five foot trailer is needed to relocate the items and the hourly rate of the truck is one hundred dollars an hour. The load time may be based at least in part on the pick-up location characteristics such as stories and elevators. The number of required movers may be based at least in part on pick-up location and/or delivery location characteristics. The truck type may be based at least in part on the item data, pick-up location characteristics and/or delivery location characteristics. The user may modify or change the location information in order to manipulate the cost of the move. For example, the user may remove extra stop “C” in order to bring the cost down. Fifth page further includes total inventory cost section 64 that displays the total cost associated with individual items to be relocated. The individual inventory cost associated with each item in section 60a is predefined or predetermined by the moving service provider in which the cost data 38 can be dynamically updated by the moving service provider.

FIG. 7 illustrated an exemplary sixth page of website interface 41 in which the sixth page includes estimated cost summary section 66, item summary section 68, logistics section 62 and total moving cost section 70. Estimated cost summary section 66 includes previously calculated cost such as total packing cost from total packing cost section 58 and total inventory cost from total inventory cost section 64, among other cost that may be dynamically calculated based at least in part on user input data, i.e., display a plurality of cost estimates. Interface 41 may further include itemization of fuel and tolls along the route for the move. The total moving cost section 70 displays the final estimated cost or total moving cost to user in which the total moving cost includes at least the total packing cost and total inventory cost.

Furthermore, device 12 and/or apparatus 14 may print and/or generate a printable estimate sheet with information for the move based at least in part on the plurality of cost estimates and user input data. For example, the estimate sheet may include items to be relocated, pick-up/delivery locations, number of movers assigned to help, number of trucks, size of trucks, payment terms, company logo(s), company contact information and notices, among other information. The printable estimate sheet provides the customer with a written version of information of the plurality of cost estimates and at least a portion of the user input data in order to help reduce ambiguity as to the terms and conditions for the move. The format of the printable estimate sheet may be dynamically reconfigured by the moving company based on design need.

Also, device 12 and/or apparatus 14 may provide user of device 12 with at least one moving tariff form including moving tariff data. Moving tariff data includes a list of charges and services that are being calculated and how these charges were calculated. For example, moving tariff data may include a description of services offered by the moving company, rates for services and items, i.e., predetermined cost, such that users can determine exact rates for certain services and how one or more of the plurality of cost estimates were calculated, i.e., how extra stop cost, packing cost, unpacking cost, total inventory cost, cost summary and/or total moving cost were calculated. The individual item cost and calculations performed by device 12 or apparatus 14 may be based at least in part on moving tariff data associated with the moving company that is affiliated with interface 41. For example, the moving company can update the prices or charges, i.e., predetermined cost, used to determine costs by modifying the moving tariff data stored in memory 34 and/or database 16. The moving tariff data may be printed on the printable estimate sheet, provided to the user via website or interface 41 and/or provided on a separate sheet(s) or form(s). Further, moving tariff data may include other information such as legal information associated with local, state and federal laws. For example, the printable estimate sheet and/or tariff form may include one or more sections relating to local, state and federal laws associated with the relocation of the plurality of items. Processor 22 may determine which local, state and federal laws to include in the printable estimate sheet based at least in part on the stops/destinations of the relocation such that the estimate sheet/tariff sheet are customized to provide local, state and federal laws associated with the relocation. While the pages of website interface 41 have been described according to page number, the page numbers, page content and fields displayed in each page may be varied or modified based on design needs. While interface 41 is describes as a website interface 41, interface 41 may be an interface provided by cost application 27, i.e., a program application stored in device 12.

Referring to FIG. 8, there is illustrated an exemplary cost process. Processor 22 determines whether location data has been received via interface 41, i.e., whether the user has input a pick-up location and destination location (Block S100). If the determination is made that location data has not been received, the determination of Block S100 may be repeated. If processor 22 determines location data has been received at interface 41, processor causes transmitter 18 to transmit a request for cost data associated with location data to apparatus 14 and/or database 16 (Block S102). In particular, the request includes location data and is requesting cost data associated with the location data such that interface 41 may calculate cost. Processor 22 determines whether cost data associated with the transmitted location data has been received (Block S104). If the determination is made that the requested cost data has not been received, the determination of Block S104 is repeated.

If the determination is made that cost data associated with location data has been received, processor 22 determines whether additional location data has been received (Block S106). For example, additional location data associated with one or more extra stops and/or temporary storage may be received. If processor 22 determines additional location data has been received, the cost application process returns to Block S102 such cost data associated with the additional location data can be requested in which the request includes the additional cost data. Additional location cost estimate may be displayed if additional location data was received (Block S108). If the determination is made that additional location data will not be received, i.e., user indicates no extra stops and/or temporary storage are needed, processor 22 causes display 24 to display a geographical map of locations corresponding the location data (Block S110). For example, interface 41 may display mapping 54.

Processor 22 determines whether carrier assistance has been requested (Block S112). For example, the user may indicate carrier assisted packing and/or unpacking are needed as illustrated in FIG. 5. If processor 22 determines carrier assistance is requested, processor 22 causes transmitter 18 to transmit a message including the carrier assisted cost data that request cost data associated with this carrier assistance data (Block S114). Processor 22 determines whether cost data associated with carrier assistance data has been received in response to message (Block S116). If processor 22 determines the cost data associated with carrier assistance data has not been received, the determination of Block S116 is repeated.

If processor 22 determines cost data associated with the carrier assistance data has been received, processor 22 determines the total carrier assistance cost based at least in part on the received cost data associated with the carrier assistance data (Block S118). Processor 22 causes display 24 to display the total carrier assistance cost (Block S120). The cost application process proceeds to Block S122 as discussed below.

Referring back to Block S112, if processor 22 determines carrier assistance is not requested, i.e., carrier assisted packing/unpacking is not requested, processor 22 determines whether item data, i.e., user input data associated with items to be relocated, has been received at interface 41 (Block S122). If processor 22 determines item data has not been received, the determination of Block S122 may be repeated. If the determination is made that item data has been received, processor 22 causes transmitter 18 to transmit a request for cost data associated with item data to apparatus 14 and/or database 16. Processor 22 determines whether the request cost data associated with the item data has been received (Block S126). If processor 22 determines the cost data associated the item data has not been received, processor 22 repeats the determination of Block S126.

If processor 22 makes the determinations that cost data associated with item data has been received, processor 22 determines a total inventory cost based at least in part on received cost data associated with the item data (Block 128). The determined total inventory cost is displayed by display 24 as illustrated FIG. 6 (Block S130). Processor 22 determines the total moving cost based at least in part on the determined additional location cost, total carrier assistance cost and total inventory cost (Block S132). Processor 22 causes display 24 to display the determined total moving cost (Block S134). Furthermore, one or more Blocks S100-S134 may be dynamically repeated based at least in part on user input data that is received from interface 41 after a respective Block has been performed, i.e., the user modifies the previously input information to customize the cost and services to the user's needs and budget.

FIG. 9 illustrates an exemplary interface process that receives data from cost application 27 running on device 12 and provides cost data such that cost application 27 may perform cost calculations. Cost application 27 may downloaded to device 12 from apparatus 14 or other server. Processor 32, at apparatus 14, determines a request for cost data associated with location data has been requested from interface 41 (Block S136). If processor 32 determines a request has not been received, processor repeats the determination of Block S136. If processor 32 determines a request for cost data associated with location data has been requested, processor 32 determines the cost data corresponding to the request (Block S138). For example, processor 32 may search memory 34 for the corresponding cost data or may alternative request the cost data from database 16. Processor causes transmitter 28 to transmit the requested cost data to interface 41 (Block S140).

Processor 22 determines whether a request for cost data associated additional location data has been requested (Block S142). If processor 32 determines a request for cost data associated with additional location data has been requested, Block S138 is repeated for the additional location data. If processor 32 determines a request for cost data associated with additional location data has not been received, processor 32 determines whether a request for cost data associated with carrier assistance data has been received (Block S144). For example, interface 41 may request cost data associated with carrier assisted packing and/or unpacking in response to receiving user input data that the user wants such assistance, as illustrated in FIG. 5.

If processor 32 determines cost data associated with carrier assistance data is requested, processor determines the requested cost data, i.e., searches memory 34 for cost data or request the corresponding cost data from database 16 (Block S146). Processor 32 causes transmitter 28 to transmit the determined cost data associated with the carrier assistance data. Processor 32 determines whether a request for cost data associated with item data has been received from interface 41 (Block S150). If processor 32 determines a request for cost data associated with item data has not been received, processor 32 repeats the determination of Block S150. If processor 22 determines the request has been received, processor 32 determines cost data associated with the item data, i.e., processor 32 search memory 34 for cost data or alternatively request cost data form database 16 (Block S152). Processor 32 causes transmitter 28 to transmit the cost data associated with the item data (Block S154). As such, interface 41 performs the cost calculations.

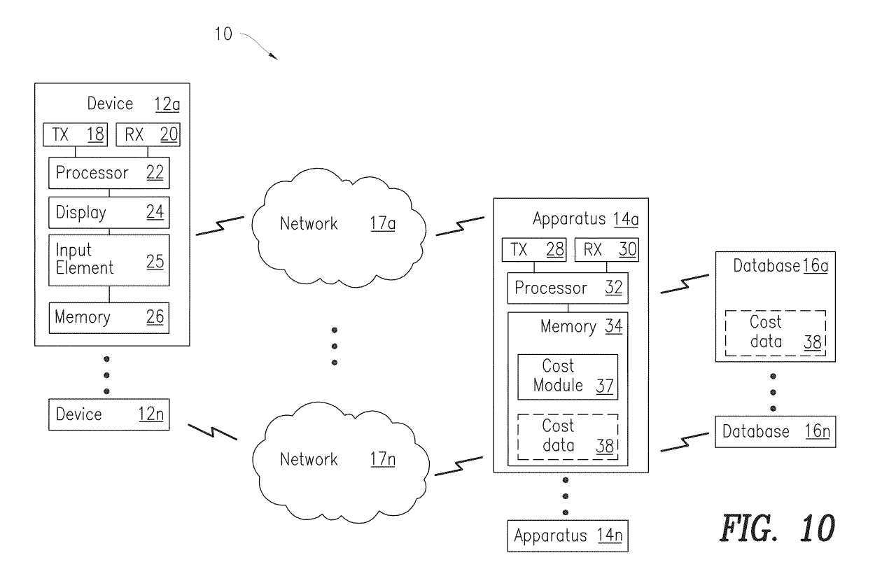

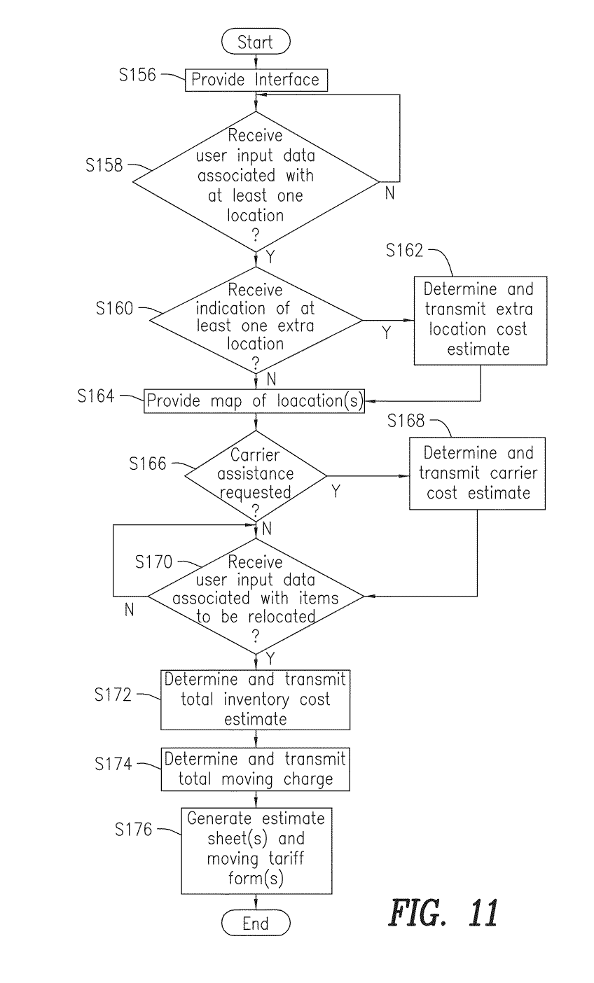

Referring to FIG. 10, there is illustrated a block diagram of an alternative embodiment of system 10. System 10 includes device 12, apparatus 14, database 16 and network 17 that substantially corresponding with like components of FIG. 1, with size and performance being based on design need and functionality of individual elements varying as described herein. In particular, memory 34 of apparatus 14 includes cost module 37 that provides interface 41, determines costs associated with the move, provides a moving cost estimate sheet and moving tariff forms. Cost module 37 includes instructions, which when executed by processor 32, causes processor 32 to perform the second cost application process, discussed in detail with respect to FIG. 11. The alternative embodiment illustrated in FIG. 10 advantageously allows apparatus 14 to perform the cost determinations of the move, thereby helping reduce the power consumption effects that processing can have on the battery life of device 12, especially if a user continuously modifies the estimate to suit his/her needs as allowed by system 10.

FIG. 11 illustrates a second cost process of cost module 38 in which apparatus 14 performs the necessary cost calculations. Apparatus 14 provides interface 41 to device 12 via network 17 (Block S156). User input data associated with relocating a plurality of items is received at interface 41 due to received user inputs at device 12 in which the user input data is subsequently relayed or transmitted to apparatus 14. In particular, processor 32 determines whether user input data associated with at least one location, i.e., a pick-up location and delivery location, has been received from device 12 via interface 41 (Block S158). If processor 32 determines user input data associated with the pick-up location and delivery location has not been received, the determination of Block S158 is repeated.

If the determination is made that user input data associated with a pick-up location and delivery location has been received, processor 32 determines whether an indication of at least one extra location has been received (Block S160). For example, processor 32 determines whether user input data associated with an extra stop (FIG. 3) and/or temporary storage (FIG. 3) has been received from device 12 via interface 41. If processor 32 determines user input data associated with at least one extra location has been received, processor 32 determines and transmits an extra location cost estimate to interface 41 for display such as for display in section 50 (Block S162). The cost data for determining the extra location cost estimate may be requested from database 16. The second cost process proceeds to Block S164 in which processor 32 determines and provides a geographical map of the locations and travel path corresponding to the user input data, e.g., pick-up location, delivery location, extra stop location, temporary storage location and the travel path between these locations are mapped as illustrated in FIG. 4.

Referring back to Block S160, if processor 32 determines an indication that at least one extra location has not been received, i.e., user does not need an extra stop location for the move, processor 32 provides a geographical map of locations corresponding to the user input data (Block S164). Processor 32 determines whether carrier assisted packing/unpacking has been requested via interface 41, i.e., whether user input data indicates carrier assistance is being requested (Block S166). For example, user input data entered at forth page of interface 41 (FIG. 5) may indicate that carrier assistance is requested and the specific quantity of boxes to be packed and/or unpacked by the carrier. If processor 32 determines an indication of carrier assistance has been received from interface 41, processor 32 determines and transmits a carrier cost estimate associated with the cost of packing and/or unpacking, by the carrier, of items to be relocated (Block S168). After block S168 is performed, the second cost process may proceed to Block S170 discussed below.

If processor 32 determines carrier assistance is not requested, processor 32 determines whether user input data associated with items to be relocated has been received from device 12 via interface 41 (Block S170). For example, apparatus 14 determines user input data from section 60b has been received in which section 60b corresponds to items that are to be relocated. If processor 32 determines user input data associated with items, i.e., item data, to be relocated has not been received, processor 32 repeats the determination of Block S170. If processor 32 determines user input data associated with items has been received, processor 32 determines a total inventory cost estimate based at least in part on the cost data associated with item to be relocated (Block S172). The cost data for determining the total inventory cost estimate may be requested from database 16. For example, the total inventory cost estimate is based at least in part on the type and number of items to be relocated that have been “dropped” into section 60b. Processor 32 may further cause transmitter 28 to transmit the determined total inventory cost estimate to interface 41 for display.

Processor 32 determines a total moving charge based at least in part on previously calculated extra location cost estimate, carrier cost estimate and total inventory cost estimate (Block S174). The cost data for determining the extra location cost estimate, carrier cost estimate and total inventory cost estimate may be requested from database 16. Processor 32 may cause transmitter 28 to transmit the determined total moving charge to interface 41. Furthermore, one or more Blocks S158-S174 may be dynamically repeated based at least in part on user input data that is received from interface 41 after a respective Block has been performed, i.e., the user modifies the previously input information to customize the cost and services to the user's needs and budget. Processor 32 may prompt user via interface 41 to pay a scheduling fee or retainer fee before the day of the move in which the scheduling fee will be credited to toward the total moving charge the day of move. The scheduling fee may be nonrefundable should the user decide not to ultimately use the moving company's services as the scheduling fee is for cost of preparation and arrangements by the moving company to handle the move. The user may be offered one or more free boxes based at least in part on amount of the scheduling fee paid by the user.

Processor 32 generates one or more estimate sheets and/or moving tariff forms (Block S176). For example, processor 32 may generate printable moving tariff forms such that the user can print out the paper work for future reference. For example, the printable estimate sheet and/or moving tariff forms may include one or more sections relating to local, state and federal laws associated with the relocation of the plurality of items. Processor 32 may determine which local, state and federal laws to include in the printable estimate sheet based at least in part on the stops/destinations of the relocation such that the estimate sheet/tariff sheet are customized to provide local, state and federal laws associated with the relocation. Furthermore, interface 41 may require the user to indicate that the estimate sheet(s) and/or moving tariff form(s) were received by the user.

Cost module 37 may also include instructions, which when executed by processor 32, cause processor 32 to provide additional functionality. For example, processor 32 may determine whether a transport truck or vehicle required to transport the plurality of items is too large to reach at least one of the pick-up, delivery and extra stop locations based at least in part on user input data. If processor 32 determines the transport truck is too large, processor 32 causes apparatus 14 to prompt the user via interface 41 as to whether the user wants to rent a shuttle truck. The shuttle truck is smaller than the transport truck and is used to transport items to/from the transport truck, i.e., the shuttle truck such as a twenty foot truck can shuttle items to/from an eighteen wheel transport truck. In one embodiment, the determination by processor 32 whether the transport truck is too large may be based on a geographical mapping of the location. Alternatively, the user may indicate via interface 41 that the transport truck is too large. If the user wants a shuttle truck as indicated by user input data, processor 32 cause the shuttle truck to be automatically rented for an additional charge. The total moving charge is dynamically updated or updated in real-time to reflect the additional charge for the shuttle truck.

Also, the cost process may further include calculating insurance coverage for moving the plurality of items from the pick-up location to the delivery location based at least in part on user input data. In particular, apparatus 14 may directly interface with various insurance providers and download data associated with cost of insurance in order to calculate the insurance coverage charge. The total moving charge may be dynamically updated based at least in part on the calculated charge of insurance. The cost process may further include prompting the user to choose at least one option for valuation coverage. The total moving cost may be dynamically updated based at least in part on the additional cost of the valuation coverage. The estimate sheet may include one or more options for valuation coverage and an indication of the option selected by the user. For example, the estimate sheet may include at least two estimates: one with valuation coverage and one without valuation coverage if waived.

The cost process may further cause processor 32 to prompt the user via interface 41 to select whether pet moving services are needed. For example, processor 32 may automatically make reservations with a predetermined pet moving company to move one or more pets if the user indicates via interface 41 that the service is needed. Furthermore, processor 32 may prompt the user via interface 41 to select whether the user wants apparatus 14 to send moving information based on user input data to the user's utility company, credit card company, mail services, internet provider and/or cable provider regarding the move. For example, processor 32 may forward the moving information to the user's cable service provider such that the cable company is aware of the move and can install the user's cable at the new home or delivery location on the day of arrival or soon thereafter.

The cost process may further cause processor 32 to verify whether the moving company associated with apparatus 14 and interface 41 is able to provide moving services on the date indicated by user input data. For example, apparatus 14 may store in memory 34 an electronic calendar of the moving company in which processor 32 determines whether the moving company is available to service the user on the date associated with the user input data. The service calendar may track availability of equipment and human resources. If processor 32 determines one or more date(s) associated with user input data are unavailable, processor 32 may prompt the user via interface 41 to enter new moving date(s).

Furthermore, processor 32 may determine whether to prompt user via interface 41 to rent a crane based at least in part on user input data. For example, user input data may indicate the user wants to move an object meeting a predefined size, weight and/or type parameter. If one of more predefined parameters are met, processor 32 may prompt user via interface 41 to select whether the user wants to rent a machine for hoisting/moving large objects such as a jack for lifting a safe or a crane for hoisting a piano. If the user selects the option to rent the crane, processor 32 automatically rents a crane or machine for moving large objects from the moving company. Alternatively, if the moving company does not offer cranes or machines for hoisting large objects, processor 32 automatically rents the crane or machine from a predetermined company. The total moving charge may be dynamically updated based at least in part on the cost to rent the crane(s) or machine(s) for hoisting large objects.

Furthermore, processor 32 prompts the user via interface 41 to select from a variety of additional moving products and/or services such as chandelier removal, curtain removal, furniture disassembly/assembly, window/door removal for oversized items, disassemble/reassemble office partitions, buying moving accessories (boxes, pads, blankets, bubble wrap, paper, popcorn, rolls of corrugated cardboard for floor protection, shrink wrap, etc.), relocating specialty items (hot tub, pool table, automobiles, etc.), placing felt on the bottom of furniture and flexible on-site arranging of furniture at a drop off location, among other products and/services. The total moving charge may be dynamically updated based at least in part on selected additional moving product(s) and/or service(s) and respective charge(s).

Cost process may further includes instructions, which when executed by processor 32, cause processor to calculate one or more discounts to offer the user to ensure the user uses the moving company based at least in part on user input data such as the size of the move, required supplies and/or other factors. For example, if the user has indicated that a predefined threshold of moving boxes are required, processor 32 may determine an amount of a potential credit to offer the user if the user purchases the boxes from a predetermined company and presents the receipt(s) to the moving company. Similarly, for other services such as door removal, furniture wrapping and packing, discounts can be offered to the customer in order to help ensure the user hires the moving company. Furthermore, the discounts may encourage the user to shop at one or more predetermined company or stores such as the store that sells boxes for moving. The specific credits, discounts, and incentives can be fully customized by the software by the moving company associated with apparatus 14 and interface 41.

For overseas moves, processor 32 may calculate the bulkhead shipping containers cost in which the total moving charge is dynamically updated, i.e., updated in real-time, based at least in part on the container cost. Interface 41 may further allow a user to indicate which items, i.e., unwanted items, they wish to donate to charity or dispose of by dragging items in section 60a to a donate or dispose section (not shown) of interface 41. The total moving charge and/or inventory charge 64 may be updated real-time based at least in part on the user's selections.

Processor 32 may add an additional overweight charge to the total moving charge of one or more items or objects that meet a predefined weight threshold. Processor 32 may add an additional charge for moves involving excessive labor as predefined by the moving company such as moves involve going up/down over three flights of stairs at the pick-up/delivery location. The total moving charge is updated in real-time based at least in part on the additional charges. Interface 41 may also allow the user to tip worker(s) associated with the move in which the total moving charge is dynamically updated based at least in part on the tip(s) entered by the user.

In another embodiment, processor 32 may prompt the user via interface 41 to select whether the user requires personal transportation the day of the move. For example, an elderly person moving to a retirement home may not have their own form of transportation and may need a taxi or car service. If the user indicates personal transportation is required, processor 32 may forward the user's contact data to a predetermined taxi or car service for scheduling. Alternatively, processor 32 may automatically reserve or book the taxi or car service for the user such that the taxi or car service shows up to transport the user the day of the move.

In an online marketplace embodiment of invention, the estimates generated for each moving company may be sent to each company for each bid, even if the company loses the bid, such that each company can track activity and adjust pricing. Accordingly, the present invention provides a system and method that allows a user to receive an instant moving quote for one or more moving related services in which the quote is customizable, by the user, by entering modified user information to suit the user's needs and budget. Also, the present invention advantageously generates printable estimate and tariff sheet(s) that allow the user to see the costs associated with the move and how the costs were calculated, among other information related to the move. Interface 41 may be available in multiple languages. It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for estimating costs associated with relocating a plurality of items, the system comprising:
an apparatus, the apparatus including:
a processor, the processor configured to:
provide an interface to a device, the interface configured to:
receive user input data associated with relocating a plurality of items; and
display a plurality of cost estimates including a total moving cost, the plurality of cost estimates being based at least in part on predefined cost data and user input data, at least one of the plurality of cost estimates being dynamically updated after at least a portion of the user input data is received; and
provide at least one of an estimate sheet and moving tariff form, the estimate sheet being based at least in part on the plurality of cost estimates and received user input data, the moving tariff form providing a list of at least one charge and service associated with the plurality of cost estimates.

2. The system of claim 1, wherein the user input data includes at least a first pick-up location and first delivery location.

3. The system of claim 2, wherein the user input data includes extra stop data associated with at least one extra stop location situated along a path of travel between the first pick-up location and first delivery location.

4. The system of claim 3, wherein the interface is further configured to display a geographical map, the geographical map indicating the first pick-up location, first delivery location, at least one extra stop location and the path of travel.

5. The system of claim 2, wherein the plurality of cost estimates further include at least one of an extra stop cost estimate and temporary storage cost estimate, the extra stop cost estimate being associated with one of a second pick-up location and second destination location located along a path of travel between the pick-up location and destination location, the temporary storage cost estimate being associated with storage of at least one of the plurality of items.

6. The system of claim 5, wherein the plurality of cost estimates further includes a packing cost estimate associated with at least one of packing and unpacking by a carrier.

7. The system of claim 1, wherein the cost data includes a plurality of individual item costs corresponding to respective items to be relocated; and
the plurality of cost estimates further includes a total inventory cost based at least in part on plurality of individual item costs.

8. The system of claim 1, further comprising:
a database in communication with the apparatus, the database configured to:
store cost data, the cost data including a plurality of individual item costs, motor vehicle cost, fuel cost and mover labor rate, the motor vehicle cost and fuel cost being based at least in part on a distance from the first pick-up location to the first destination location; and
provide cost data to the apparatus, the total moving cost being based at least in part on the individual item cost, motor vehicle cost, fuel cost and labor rate.

9. A method for estimating costs associated with relocating a plurality of items, the method comprising:
providing an interface to a device, the interface configured to:
receive user input data associated with relocating a plurality of items; and
display a plurality of cost estimates including a total moving cost, the plurality of cost estimates being based at least in part on predefined item cost and user input data, at least one of the plurality of cost estimates being dynamically updated after at least a portion of the user input data is received; and
providing at least one of a estimate sheet and moving tariff form, the estimate sheet being based at least in part on the plurality of cost estimates and received user input data, the moving tariff form providing at list of at least one charge and service associated with the plurality of cost estimates.

10. The method of claim 9, wherein the user input data includes at least a first pick-up location and first delivery location.

11. The method of claim 10, wherein the user input data includes extra stop data associated with at least one extra stop location situated along a path of travel between the first pick-up location and first delivery location.

12. The method of claim 10, wherein the interface is further configured to display a geographical map, the geographical map indicating the first pick-up location, first delivery location, extra stop location and the path of travel.

13. The method of claim 9, wherein the at least one of estimate sheet and moving tariff form include applicable laws associated with interstate relocation of the plurality of items.

14. The method of claim 9, wherein the cost data includes a plurality of individual item costs corresponding to respective items to be relocated; and
the plurality of cost estimates further includes a total inventory cost based at least in part on plurality of individual item costs.

15. The method of claim 9, wherein the plurality of cost estimates further includes at least one of an extra stop cost estimate and temporary storage cost estimate, the extra stop cost estimate being associated with one of a second pick-up location and second destination location located along a path of travel between the pick-up location and destination location, the temporary storage cost estimate being associated with storage of at least one of the plurality of items.

16. The method of claim 9, further comprising storing cost data, the cost data including a plurality of individual item costs, motor vehicle cost, fuel cost and mover labor rate, the motor vehicle cost and fuel cost being based at least in part on a distance from the first pick-up location to the first destination location.

17. The method of claim 15, wherein the cost data includes a plurality of individual item costs corresponding to respective items to be relocated; and
the plurality of cost estimates further includes a total inventory cost based at least in part on plurality of individual item costs.

18. A system for estimating costs associated with relocating a plurality of items, the system comprising:
an apparatus, the apparatus including:
a processor, the processor configured to:
provide an interface to a device, the interface configured to:
receive user input data associated with relocating a plurality of items; and
display a plurality of cost estimates including a total moving cost, the plurality of cost estimates being based at least in part on predefined cost data and user input data, at least one of the plurality of cost estimates being dynamically updated after at least a portion of the user input data is received; and
provide at least one of a estimate sheet and moving tariff form, the estimate sheet being based at least in part on the plurality of cost estimates and received user input data, the moving tariff form providing at list of at least one charge and service associated with the plurality of cost estimates; and
a database in communication with the apparatus, the database configured to:
store cost data, the cost data including a plurality of individual item costs, motor vehicle cost, fuel cost and mover labor rate, the motor vehicle cost and fuel cost being based at least in part on a distance from the first pick-up location to the first destination location; and
provide cost data to the apparatus, the total moving cost being based at least in part on the individual item cost, motor vehicle cost, fuel cost and labor rate.

19. The system of claim 18, wherein the user input data includes at least a first pick-up location, first delivery location and extra stop data, the extra stop data being associated with at least one extra stop location situated along a path of travel between the first pick-up location and first delivery location.

20. The system of claim 19, wherein the plurality of cost estimates further include at least one of an extra stop cost estimate and temporary storage cost estimate, the extra stop cost estimate being associated with one of a second pick-up location and second destination location located along a path of travel between the pick-up location and destination location, the temporary storage cost estimate being associated with storage of at least one of the plurality of items; and
the at least one of a estimate sheet and moving tariff form includes applicable laws associated with interstate relation of the plurality of item.
